(19) United States
(12) Patent Application Publication
(10) Pub. No.: US 2016/0071035 A1
(43) Pub. Date: Mar. 10, 2016

(54) IMPLEMENTING SOCIALLY ENABLED BUSINESS RISK MANAGEMENT

(71) Applicant: International Business Machines Corporation, Armonk, NY (US)

(72) Inventors: Yi-Min Chee, Yorktown Heights, NY (US); Michele M. Franceshini, White Plains, NY (US); Ashish Jagmohan, Irvington, NY (US); Elham Khabiri, Yorktown Heights, MD (US); Luis A. Lastras-Montano, Cortlandt Manor, NY (US); Debdoot Mukherjee, Kolkata (IN); Krishna C. Ratakonda, Yorktown Heights, NY (US)

(21) Appl. No.: 14/478,516

(22) Filed: Sep. 5, 2014

(51) Int. Cl. G06Q 10/06

(52) U.S. Cl. CPC G06Q 10/0635

(57) ABSTRACT

A method that comprises receiving a plurality of inputs including data a plurality of multiple business repositories, generating from the plurality of inputs a corpus graph as a statistical relational network, inferring a plurality of new relations between informational elements of the statistical relational network, and generating a plurality of summaries of the plurality of new relations. Further, each summary describes the informational elements of the statistical relational network associated with a corresponding risk-relation.

### BACKGROUND

The disclosure relates generally to social enterprise enabled risk management, and more specifically, to a social enterprise enabled risk management system and method that receives data from a plurality of sources in a plurality of forms, searches the data to identify business risks, and summarizes the business risks for user review.

In general, business enterprises and other organizations often are administrated by a number of executives and managers distributed across multiple business repositories in various locations. Executives and managers in such enterprises and other organizations face the challenge of disseminating and sharing accumulated enterprise information that may be relevant to issues confronted by various departments or business units throughout the enterprise. For example, managers of newer projects frequently confront the same or similar issues that have been previously met and addressed by other managers of earlier projects that had some commonality with the newer projects, such as a common technology, a common customer, or a common business goal. Yet, the proliferation of multiple types of stored data across multiple enterprise platforms have made it increasingly difficult for individual managers to identify and locate information relevant to those same or similar issues that has been accumulated at an enterprise level.

### SUMMARY

According to one embodiment of the present invention, a method that comprises receiving a plurality of inputs including data from a plurality of multiple business repositories, generating from the plurality of inputs a corpus graph as a statistical relational network, inferring a plurality of new relations between informational elements of the statistical relational network, and generating a plurality of summaries of the plurality of new relations, wherein each summary describes the informational elements of the statistical relational network associated with a corresponding risk-relation.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a process flow of a social enterprise enabled risk management (SEER) system;

FIG. 2 illustrates a computing device schematic configured to provide SEER processes described herein;

FIG. 3 illustrates a process flow of a SEER system;

FIG. 4 illustrates a process flow of a SEER system;

FIG. 5 illustrates a process flow of a SEER system; and

FIG. 6 illustrates an example of a corpus graph as generated by a SEER system.

### DETAILED DESCRIPTION

As indicated above, it is increasingly difficult for individual managers to identify and locate information relevant to their project that has been accumulated at an enterprise level. Thus, what is needed is a social enterprise enabled risk management system and method that receives information from a plurality of sources in a plurality of forms, searches the information to identify business risks, and summarizes the business risks for manager review.

In general, a social enterprise enabled risk management (SEER) system and method implements enterprise risk management by knowledge extraction and graph formation in specialized financial and business domains, social business enablement that locates contextually similar projects and contextually relevant experts using inferences based on the extracted graph, and risk-driven textual summaries of the located projects for user review.

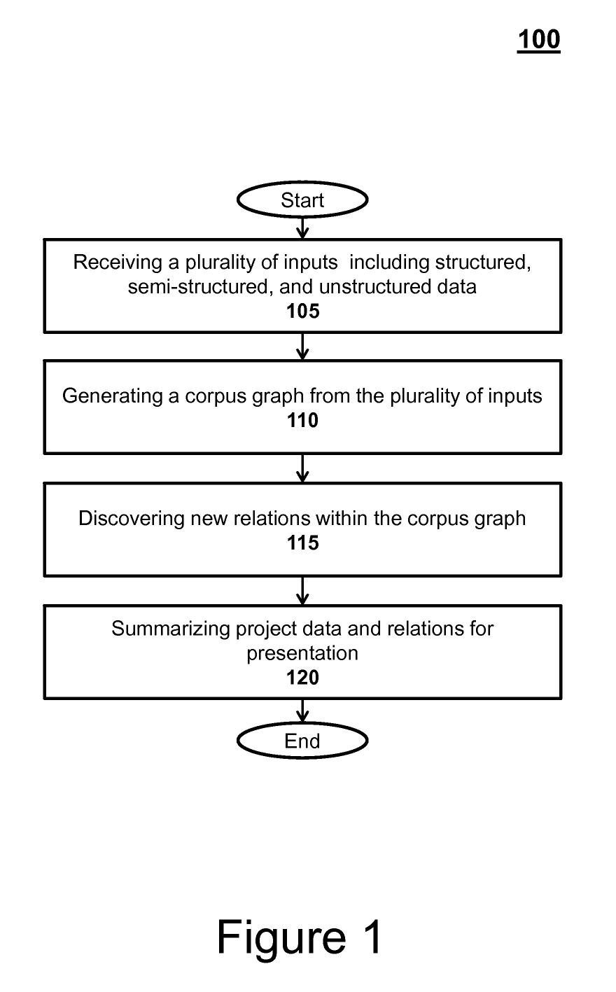

For example, an operation of the SEER system and method is described with reference to FIG. 1, which illustrates process flow 100. The process flow 100 begins at block 105 when the SEER system and method receives information (e.g., a plurality of inputs) including structured, semi-structured, and unstructured data from multiple business repositories in various locations. For instance, given a repository of risk management documents and/or project management documents, the SEER system and method accumulates the structured, semi-structured, and unstructured data of those documents that details goals, risks, technologies, and experts from the repository. At block 110, the SEER system and method generates corpus graph from the structured, semi-structured, and unstructured data by extracting corpus-wide risk concepts, identifying textual risk segments, and performing technology, expert, and client recognition operations from/on the accumulated data. In this way, the risk concepts, risk segments, and recognized data are utilized to build an enterprise-specific statistical relational network (e.g., in a graphical representation) where meaningful enterprise management relationships are inferred and fused between the accumulated but unconnected data. The process flow 100 proceeds to block 115 where the SEER system and method discovers new relations within the corpus graph. For instance, the SEER system and method identifies and/or infers additional relations (e.g., new relations) between informational elements of the enterprise-specific statistical relational network, which initially were unconnected. At block 120, the SEER system and method generates summaries of the new relations for presentation and also generate summaries of the project data, including the unstructured and structured project data. Thus, via the summaries, the SEER system and method enables user access to information regarding current or previous enterprise projects that share similar goals, risks, technologies, and experts. Then, the process flow 100 ends.

In view of the above, embodiments of the present invention disclosed herein may include a SEER system, method, and/or computer program product that receives a plurality of inputs including data from a plurality of multiple business repositories, generates from the plurality of inputs a corpus graph as a statistical relational network, infers a plurality of new relations between informational elements of the statistical relational network, and generates a plurality of summaries of the plurality of new relations, wherein each summary describes the informational elements of the statistical relational network associated with a corresponding risk-relation.

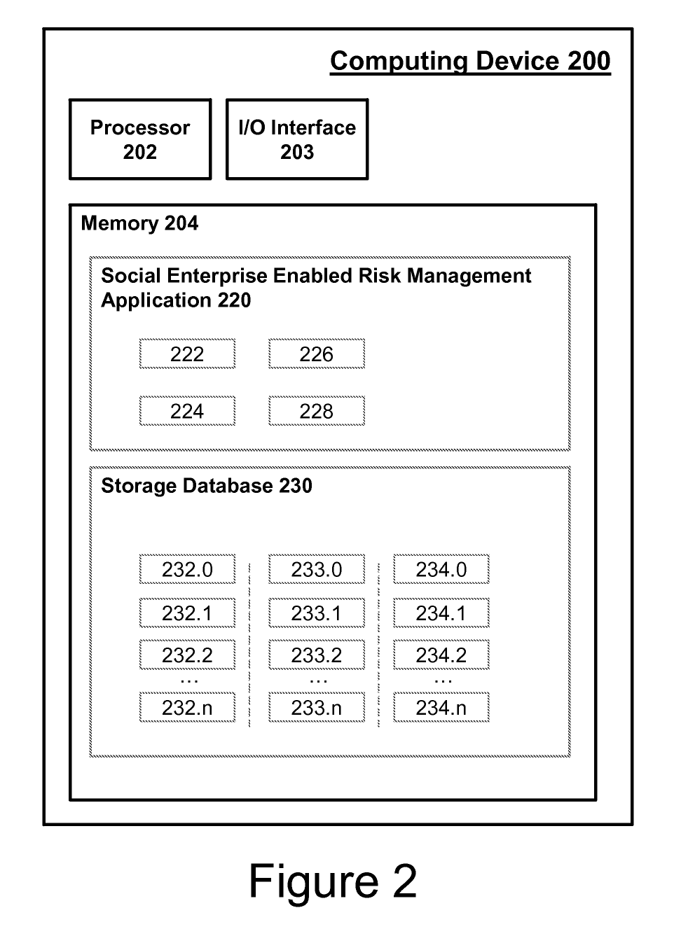

Systems and/or computing devices, such as the SEER system (e.g., computing device 200 of FIG. 2 below), may employ any of a number of computer operating systems, including, but by no means limited to, versions and/or varieties of the AIX UNIX operating system distributed by International Business Machines of Armonk, N.Y., the Microsoft Windows operating system, the Unix operating system (e.g., the Solaris operating system distributed by Oracle Corporation of Redwood Shores, Calif.), the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, a computer workstation, a server, a desktop, a notebook, a laptop, a network device, a handheld computer, or some other computing system and/or device.

In general, computing devices may include a processor (e.g., a processor 202 of FIG. 2) and a computer readable storage medium (e.g., a memory 204 of FIG. 2), where the processor receives computer readable program instructions, e.g., from the computer readable storage medium, and executes these instructions, thereby performing one or more processes, including one or more of the processes described herein (e.g., SEER processes).

Computer readable program instructions may be compiled or interpreted from computer programs created using assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on a computing device, partly on the computing device, as a stand-alone software package, partly on a local computing device and partly on a remote computer device or entirely on the remote computer device. In the latter scenario, the remote computer may be connected to the local computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention. Computer readable program instructions described herein may also be downloaded to respective computing/processing devices from a computer readable storage medium or to an external computer or external storage device via a network (e.g., any combination of computing devices and connections that support communication). For example, a network may be the Internet, a local area network, a wide area network and/or a wireless network, comprise copper transmission cables, optical transmission fibers, wireless transmission, routers, firewalls, switches, gateway computers and/or edge servers, and utilize a plurality of communication technologies, such as radio technologies, cellular technologies, etc.

Computer readable storage mediums may be a tangible device that retains and stores instructions for use by an instruction execution device (e.g., a computing device as described above). A computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Thus, SEER system and method and/or elements thereof may be implemented as computer readable program instructions on one or more computing devices, stored on computer readable storage medium associated therewith. A computer program product may comprise such computer readable program instructions stored on computer readable storage medium for carrying and/or causing a processor to carry out the operations of SEER system and method.

FIG. 2 illustrates a computing device 201 (e.g., a computing device as described above) configured to provide a SEER operation that includes a processor 202, an input/output interface 203, and a memory 204. The processor 202 may receive computer readable program instructions from the memory 204 and execute these instructions, thereby performing one or more processes defined by a SEER application 220.

The processor 202 may include any processing hardware, software, or combination of hardware and software utilized by the computing device 201 that carries out the computer readable program instructions by performing arithmetical, logical, and/or input/output operations. Examples of the processor 202 include, but are not limited to an arithmetic logic unit, which performs arithmetic and logical operations; a control unit, which extracts, decodes, and executes instructions from a memory; and an array unit, which utilizes multiple parallel computing elements.

The input/output (I/O) interface 203 may include a physical and/or virtual mechanism utilized by the computing device 201 to communicate between elements internal and/or external to the computing device 201. That is, the I/O interface 203 may be configured to receive or send signals or data within or for the computing device 201. An example of the I/O interface 203 may include a network adapter card or network interface configured to receive computer readable program instructions from a network and forward the computer readable program instructions, original records, or the like for storage in a computer readable storage medium (e.g., memory 204) within the respective computing/processing device (e.g., computing device 201).

The memory 204 may include a tangible device that retains and stores computer readable program instructions, as provided by the SEER application 220, for use by the processor 202 of the computing device 201.

The SEER application 220 may include computer readable program instructions configured to receive and reduce business document corpora from a storage database 230 (as further described below) to domain-specific graph networks of domain-relevant concepts (e.g. risks, actions, experts, technology) and perform graph-driven concept extraction, concept classification, and document summarization. Further, the SEER application 220 is configured to provide a context and relational network-driven social media framework for collaborative enterprise problem-solving. For instance, the SEER application 220 is configured to extract certain attributes or concept sets from enterprise projects to build a meaningful graphical representation of an enterprise-specific statistical relational network, infer meaningful enterprise management relationships between unconnected attributes, and fuse relevant information.

For example, the SEER application 220 may transform a specialized unstructured corpus, such as online documents and social media discussions, into a relational network of domain specific-concepts, which may facilitate data exploration of large, specialized text repositories. The SEER application 220 may implement graph inference techniques on the relational network to locate contextually-relevant textual information, including contextually-relevant experts, and perform predictive analytics with respect to the information. The SEER application 220 may further provide concept-driven summarization of the information to yield quality summaries for specialized domains and facilitate collaborative enhancement of the relational network. The SEER application 220 may in turn provide a public sharing space in the form of social media to fulfill sharing needs, such that the summaries may be accessed. In this way, the SEER application 220 strikes a balance in the tradeoff between building small communities of projects and having all discussions in one space. In addition, the SEER application 220 may provide a relational network framework to maintain a high level of organization in a public sharing space solution and suggest controlled vocabulary based on graphical data to improve organization with regard to the public sharing space solution.

The SEER application 220 is also configured to generate concept sets or holistic, specialized profiles, such as technology or risks, that arrange the received/reduced business document corpora in a readily identified and located form. The SEER application 220 is configured to infer domain-relevant relations, along with being able to be deployed over diverse specialized domains, or contexts, such as risk management, project management, production support, finance, insurance, retail, or the like. The SEER application 220 is configured to enable knowledge sharing in an enterprise, along with employee involvement and personal investment, while providing flexibility in integrating newly generated concepts to the graphical relational network and forms. For instance, the SEER application 220 may identify subject matter experts in the enterprise by monitoring enterprise social media discussion threads and may aid the understanding of enterprise problems and challenges by using indicators. The SEER application 220 is configured to provide search operations.

Therefore, the SEER application 220 is configured to infer related projects, technologies, risk factors, experts, or other attributes or technical entities, through a holistic model that encapsulates multiple facets of a collection of concepts describing risk factors, technologies, clients, product lines, strategies, mitigation actions, and the like. Thus, meaningful concepts may be discovered through a process of knowledge mining and enterprise projects, clients, products, or the like may be simplified in a representation of concepts, such as risk factors, technologies, and/or actions. The SEER application 220 may include a plurality of modules implemented as computer readable program instructions configured to implement any combination of operations described above. For example, the SEER application 220 may include a graphical network creation module 222, a relation inference module 224, a summarization module 226, and a social media module 228.

The graphical network creation module 222 may be configured to perform knowledge extraction, including graph-driven concept extraction, for example, in specialized financial and business domains, and to perform graphical relational network formation to represent enterprise information and map relations between various informational elements of the relational network, or knowledge graph. The graphical network creation module 222 may reduce unstructured business document corpora to domain-specific graphical networks of domain-relevant concepts, such as projects, accounts, technologies, actions, subject matter experts, and risk factors.

The relation inference module 224 may be configured to identify, discover or infer additional relations between informational elements of the extracted graph that initially are not directly connected by mapped relations, based, for example on extracted text and concepts. The relation inference module 224 may also be configured to define classifications and associate the informational elements with the defined classifications.

The relation inference module 224 may be configured to implement statistical graph-inference algorithms to identify, or find, relations between technical entity nodes of the relational network. The relation inference module 224 may be configured to update strength of relationships based on co-occurrence patterns of concept-tags and contexts.

The summarization module 226 may be configured to receive concept-tags, such as project concept-tags, as well as unstructured concept data, such as unstructured project data (e.g., unstructured data instances 234 as described below), and to generate summaries that describe informational elements of the knowledge graph, including, for example, document summarization. The social media module 228 may provide a social media interface, for example, an enterprise microblogging platform between users that may leverage the information in the graphical relational network.

While single items are illustrated for the SEER application 220 (and other items) by FIG. 2, these representations are not intended to be limiting, and thus the SEER application 220 items may represent a plurality of applications. For example, multiple SEER applications in different locations may be utilized to access and/or collect information, and in turn those same applications may be used for on-demand data retrieval. In addition, although one modular breakdown of the SEER application 220 is offered, it should be understood that the same operability may be provided using fewer, greater, or differently named modules, which include computer readable program instructions configured to any combination of operations described herein. Although it is not specifically illustrated in the figures, the SEER application 220 may further include a user interface module and an application programmable interface module; however, these modules may be integrated with any of the above named modules. A user interface module may include computer readable program instructions configured to generate and mange user interfaces that receive inputs and present outputs. An application programmable interface module may include computer readable program instructions configured to specify how other modules, applications, devices, and systems interact with each other.

The storage database 230 may include a database, data repository, or other data store and may include various kinds of mechanisms for storing, accessing, and retrieving various kinds of data, including a hierarchical database, a set of files in a file system, an application database in a proprietary format, a relational database management system (RDBMS), etc. The storage database 230 may generally be included within a computing device (e.g., computing device 201) employing a computer operating system such as one of those mentioned above and is accessed via a network in any one or more of a variety of manners.

The storage database is capable of storing risk management documents and/or project management documents. The storage database 230 is in communication with the SEER application 220 and/or applications external to the computing device 201, such that information, data structures, and documents including data instances may be collected and archived in support of the processes described herein (e.g., SEER process). As illustrated in FIG. 2, the storage database 230 includes a plurality of data instances 232, 233, 234, illustrated as structured data instance 232.0 to structured data instance 232.n, semi-structured data instance 233.0 to semi-structured data instance 233.n, and unstructured data instance 234.0 to unstructured data instance 234.n, where ‘n’ is an integer representing a number structures archived by the storage database 230. Although one exemplary numbering sequence for the records of the storage database 230 is offered, it should be understood that the same operability may be provided using fewer, greater, or differently implemented sequences.

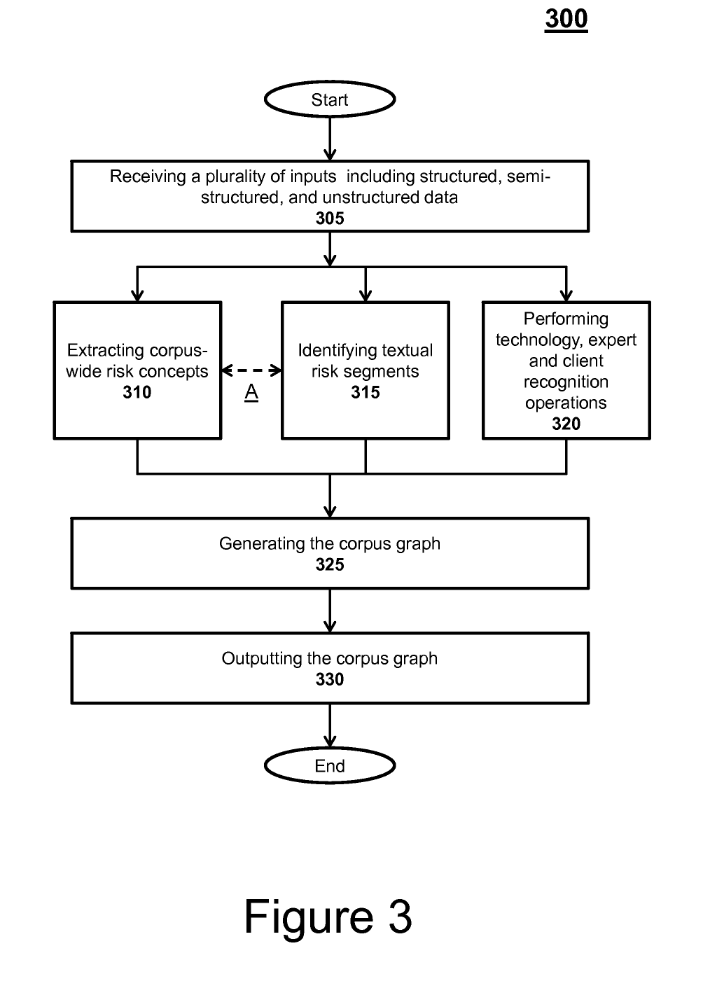

The SEER application 220 will be described with reference to FIGS. 3-5, which illustrates process flows 300, 400, 500. Note that the process flows 300, 400, 500 elaborate on specific portions of 100, e.g., blocks 110, 115, and 120 respectively.

The process flow 300 begins at block 305 when the SEER application 220 receives a plurality of inputs including structured, semi-structured, and unstructured data from multiple business repositories in various locations. For instance, the storage database may provide a plurality of risk and/or project management documents that include the data instances 232, 233, 234 of those documents, which detail goals, risks, technologies, experts, etc.

Next, either simultaneously as illustrated and/or sequentially, the graphical network creation module 222 of the SEER application 220, at block 310, extracts corpus-wide risk concepts; at block 315, identifies textual risk segments; and at block 320, performs technology, expert, and client recognition operations.

Particularly, at block 310, analytics are performed on the plurality of inputs that enable corpus-wide risk concept extraction. Examples of the analytics include phrase detection, comparative domain and non-domain name operations concept equivalent assessments, and subject matter expert refinement. At block 315, identification of textual risk segments from the plurality of inputs is executed by support-vector classifiers that automatically identify textual segments describing risks. Further, an iterative semi-automated identification of risk-concepts may be performed by the graphical network creation module 222 along with a clustering of equivalent concepts and a tagging of textual risk-segments with risk-concepts. At block 320, technology, expert, and client recognition is based on using supervised named-entity recognition and may be assisted by a dictionary. Note that arrow A of FIG. 3 illustrates the iterative nature between extracting corpus-wide risk concepts and identifying textual risk segments, as these two operations may rely on the results of the other to refine new relations of the corpus graph.

For instance, a textual segment from a first project ‘Project A’ may include the following unstructured data:

“[Our organization does not have a concrete action plan to switch to the needed technologies.] [The client is not ready to extend the contract in the absence of any concrete acceptable technology replacement plan.] Ideally, our project management team would like to train our employees in the new technologies within the next few months.”
The brackets have been added to illustrate risk sentences identified by the graphical network creation module 222, while the un-bracketed sentences are non-risk sentences. The risk sentences may be identified based on a phrase detection of phrases such as “not have a concrete action plan” which have risk concepts such as “action plan” in a negative context. In an embodiment, a classifier such as one based on support vector classification automatically identifies such risk sentences based on risk concepts and context provided by the other words in the sentence. Further, other examples of risk-concepts extracted from the above Project A textual segment include technology, technology replacement, training, contract, and contract extension. Also, the risk-concepts are not always explicit problems, and sometimes may be areas around which there is risk (“contract”, “technologies”). Further, technology concepts extracted from Project A may include proprietary software (e.g., application products and mobile device management).

Further, textual segments from a second project ‘Project B’ may include the following unstructured data:

“There are regular steering meetings. Key executives from our organization and the client leadership are both in attendance. [However we lack a consistent roadmap and clarity over our role in the project.] [The staffing does not appear to map effectively to the schedule and scope.]”
Similarly to Project A, the brackets have been added to illustrate risk sentences of Project B that have been identified by the graphical network creation module 222, while the un-bracketed sentences are non-risk sentences. The risk sentences of Project B may be identified based on phrase detection of phrases such as “lack a consistent roadmap” containing risk-related concepts such as “roadmap” and “consistency”.

The process flow 300 proceeds to block 325, where the SEER application 220 generates the corpus graph, for example, as a multi-partite project-risk-technology-client-expert graph where the edge weight is a function of a classifier confidence, probability, and frequency of term occurrence. In one embodiment, the graph is a bipartite graph with project nodes forming one partition, and risk-technology-client-expert nodes forming the other partition. The edges connecting nodes are weighted, with weights representing the probability that the connection has been correctly inferred; for example, a project node and a risk node may be connected by an edge, whose weight represents the probability the risk concept has been correctly identified as being a risk factor in the project. In this way, the risk concepts, risk segments, and recognized data are utilized to build a statistical relational network to support meaningful relationship inferences.

Next at block 330, the SEER application 220 outputs the corpus graph. For instance, the graphical network creation module 222 outputs the corpus graph (e.g., statistical relational network) to the relation inference module 224. Then, the process flow 300 ends. In this way, the SEER application 220 utilizes the risk concepts, risk segments, and recognized data to build an enterprise-specific statistical relational network (e.g., in a graphical representation) where meaningful enterprise management relationships are inferred and fused between the accumulated but unconnected data. The process flow 100 proceeds to block 115 where the SEER system and method discovers new relations within the corpus graph.

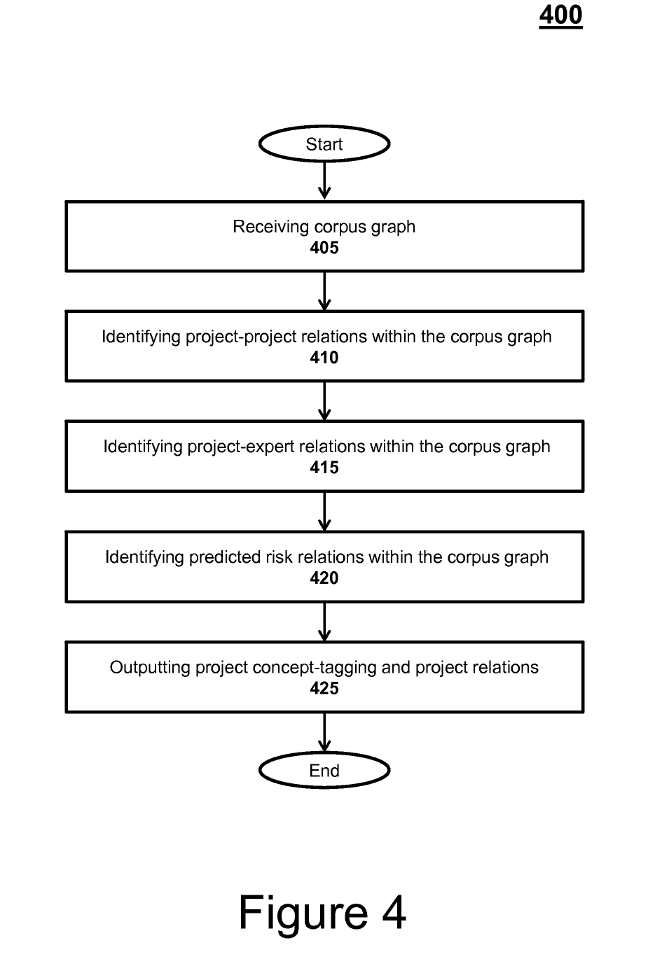

The SEER application 220 next identifies and/or infers additional relations (e.g., the relation inference module 224 of the SEER application 220 discovers new relations within the corpus graph by identifying and/or inferring new relations) between informational elements of the enterprise-specific statistical relational network via process flow 400 as seen in FIG. 4. That is, the process flow 400 begins at block 405 when the corpus graph, as produced by the process flow 300, is received by the SEER application 220.

For instance, the SEER application 220, at block 410, identifies project-project relations within the corpus graph; at block 415, identifies project-expert relations within the corpus graph; and identifies, at block 420, predicted risk relations within the corpus graph. That is, the SEER application by identifying, through the graph, past projects with similar risks and/or technologies, the relation inference module 224 identifies experts who may be able to help based on past projects given a current project of interest.

Particularly, at block 410, the relation inference module 224 may find past projects with similar profiles, such as similar risk technology profiles, as a project under consideration, by utilizing a node similarity metric that measures the graph relatedness of other project nodes to the current project node. In one embodiment, the node similarity metric computes the stationary probability distribution, or an approximation thereof, for a random Markov walk on the graph from the current project, with edge-following probabilities being functions of a node type and degree of each node. The stationary probability computed for the other project nodes are then used to yield a coarse ranking of their relatedness to the current project node. Further, the relation inference module 224 may utilize other ranking layers such as ranking based on weighted intersections of neighbor sets between project nodes, and/or point-wise data, along with mutual information, to find a finer ranking of past projects with similar profiles. Similarly, at block 415, the relation inference module 224 may find experts who have worked on similar types of projects in the past based on the mechanisms itemized by the block 410. In an embodiment, finding experts by the relation inference module 224 includes finding the expert nodes that are most related to the current project node via metrics, such as the stationary probability distribution metric, weighted intersections, point-wise mutual information, etc. To yield predicted risk relations, the relation inference module 224 (block 420) may discover a likely to occur risk in a given risk/technology profile by utilizing point-wise multi-information with conditional independence assumptions.

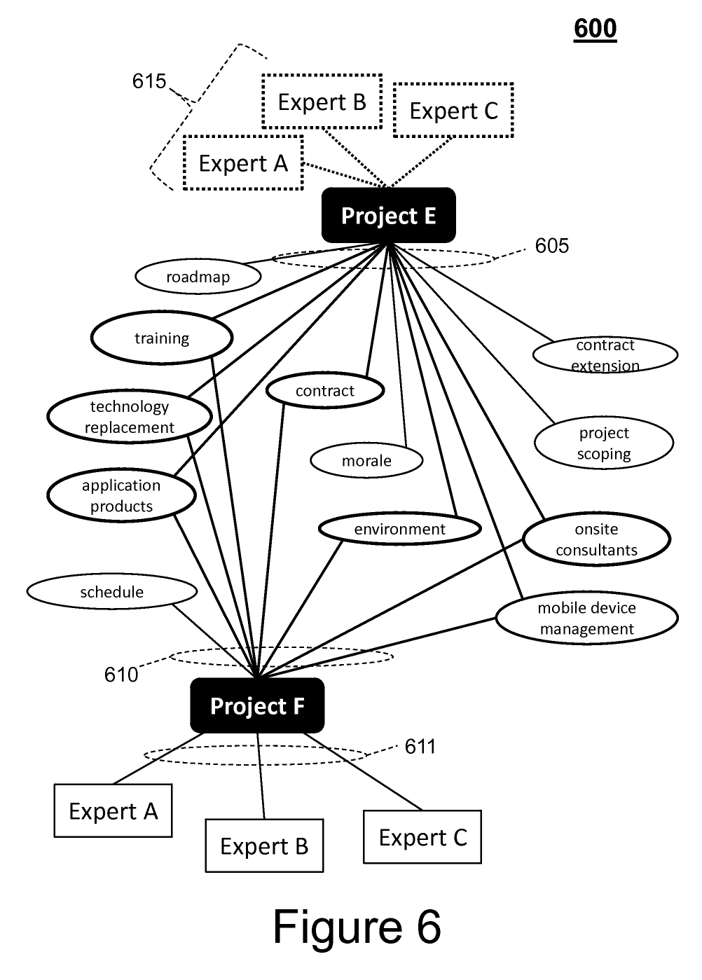

For example, if a third project ‘Project C’ indicated risks around technology replacement, training etc., and/or technology concepts, then the SEER application 220 would identifies Project A, a past project having a very similar risk/technology profile. Further, the experts of Project A may be established as possible experts for Project C by the SEER application 220 (e.g., as seen in FIG. 6 described below), who may be able to help take actions which can mitigate the risks found in Project C by the SEER application 220. In another example, based on a current risk profile of a current project ‘Project D’, the graph may show that risks related to technology replacement are likely. In turn, the SEER application 220 may identify risks that you might encounter in the future on Project D, based on risk/technology profiles of Project A. This could allow proactive actions to be taken to eliminate these potential risks.

Next at block 425, the SEER application 220 outputs the concept-tagging and project relations, for instance, to the summarization module 226. Then, the process flow 400 ends.

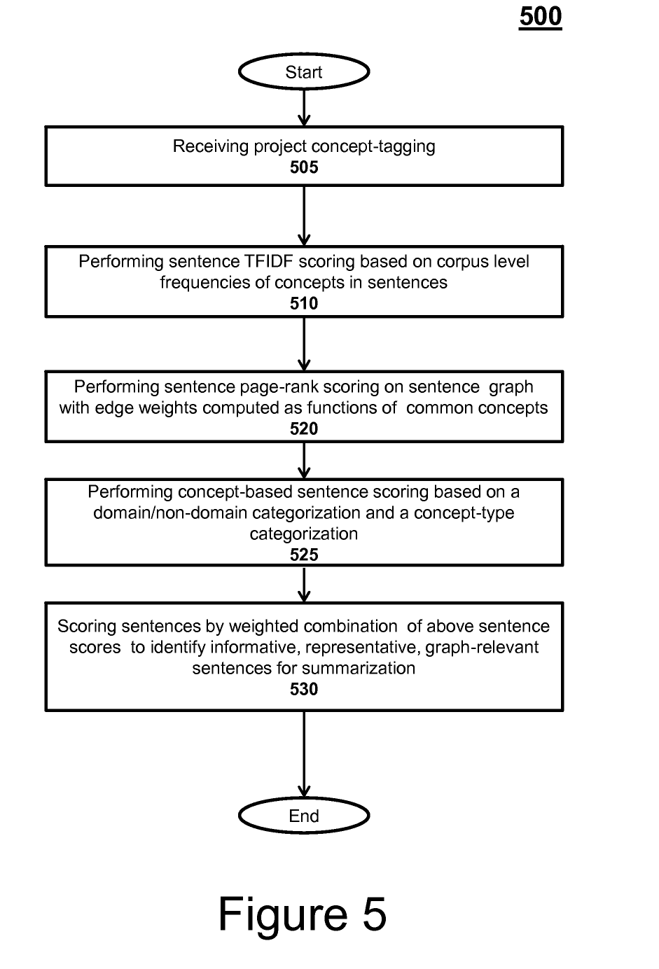

The SEER application 220 then generates summaries of the new relations via process flow 500 as seen in FIG. 5. That is, the process flow 500 begins at block 505 when the summarization module 226 of the SEER application 220 receives project concept-tagging, as output from the process flow 400, and receives unstructured project data The process flow 500 identifies informative, representative, graph-relevant sentences for summarization of the project from the project concept-tagging and unstructured project data.

The process flow 500 proceeds to block 510 where the summarization module 226 performs sentence term frequency—inverse document frequency (TFIDF) scoring based on document and corpus level frequencies of concepts contained in the sentences. TFIDF is a numerical statistic that is reflects how important a concept (which can be a work or a phrase) is to a textual segment (such as a sentence or a document) in a collection or corpus. In an exemplary embodiment, at block 510, TFIDF scores for each concept in a sentence are computed by treating each sentence as a textual segment and treating the document as a collection of sentences. The TFIDF score for a sentence is then computed as a sum of the TFIDF scores of the concepts in the sentence. Then, at block 520, the summarization module 226 implements sentence page-rank scoring. For this, it considers a graph wherein each node represents a sentence, and the weight of an edge connecting two nodes is computed as a function of the number of the concepts which are common to the sentences. The page-rank scoring thus assigns higher scores to sentences which have many concepts in common with other sentences. In another embodiment, the edge weight is additionally a function of the types of concepts which are common to the two sentences; thus, for example an infrequently occurring concept which is common may contribute more to the edge weight than a frequently occurring concept which is common.

The process flow 500 proceeds to block 525 where the summarization module 226 performs concept-based sentence weighting based on a domain/non-domain categorization and a concept-type categorization. Here sentences that have a larger number of domain-specific concepts and a larger number of “important” concepts, such as risk concepts and technology concepts, are more highly weighted than sentences with fewer numbers of such concepts. Next, at block 530, the summarization module 226 performs a weighted combination of the scores computed by blocks 510, 520 and 525 for each sentence. In turn, the summarization module 226 generates a risk summary of the project, by selecting the highest scored sentences. This summary, as well as the relations identified in project flow 400 are output by the system.

Thus, via the identified relations and the project summaries, the SEER application 220 enables user access to information regarding current or previous enterprise projects that share similar goals, risks, technologies, and experts. Then, the process flow 500 ends.

In view of the above, a corpus graph 600 as generated by the SEER application 220 will now be described with reference to FIG. 6. FIG. 6 illustrates an example of establishing possible experts for projects based on risk- and technology concept association. As illustrated, the SEER application 220 extracts risk- and technology-concepts from Project E, via the process flow 300. These Project E risk-concepts include training, technology replacement, roadmap, schedule, project scoping, contract extension, morale etc. and are associated with Project E as illustrated by lines 605. The technology concepts may include, for example, application products and mobile device management. Similarly, the SEER application 220 extracts risk- and technology-concepts from Project F, via the process flow 300. These Project F concepts include technology replacement, contract, environment, training, SAP etc. and are associated with Project F as illustrated by lines 610. Further, the SEER application 220 identifies that Project F has the associated experts of Expert A, Expert B, and Expert C, as illustrated by lines 611. Once the corpus graph 600 is constructed, the SEER application 220 identifies project-expert relations within the corpus graph 600; thereby utilizing the common risk concepts of technology replacement, training, application products, mobile device management, etc. to suggest 615 Expert A, Expert B, and Expert C as possible expert resources for Project E.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the operations/acts specified in the flowchart and/or block diagram block or blocks. These computer readable program instructions may also be stored in a computer readable storage medium that can direct a computer, a programmable data processing apparatus, and/or other devices to operate in a particular manner, such that the computer readable storage medium having instructions stored therein comprises an article of manufacture including instructions which implement aspects of the operation/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the operations/acts specified in the flowchart and/or block diagram block or blocks.

The flowchart and block diagrams in the Figures illustrate the architecture, operability, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical operation(s). In some alternative implementations, the operations noted in the block may occur out of the order noted in the Figures. For example, two blocks shown in succession may, in fact, be executed substantially concurrently, or the blocks may sometimes be executed in the reverse order, depending upon the operability involved. It will also be noted that each block of the block diagrams and/or flowchart illustration, and combinations of blocks in the block diagrams and/or flowchart illustration, can be implemented by special purpose hardware-based systems that perform the specified operations or acts or carry out combinations of special purpose hardware and computer instructions. Thus, among the advantages of the present invention embodiments are improvements to technology, including, but not limited to, unique software implementation(s), and advances in precision and speed unrealizable by human capabilities with respect to analyzing/processing voluminous data amounts, etc.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method, comprising:
receiving, by a processor, a plurality of inputs including data a plurality of multiple business repositories;
generating, by the processor, from the plurality of inputs a corpus graph as a statistical relational network;
inferring, by the processor, a plurality of new relations between informational elements of the statistical relational network; and
generating, by the processor, a plurality of summaries of the plurality of new relations, each summary describing the informational elements of the statistical relational network associated with that corresponding risk-relation.

2. The method of claim 1, wherein the a plurality of inputs includes risk or project management documents, each document including at least one of structured, semi-structured, and unstructured data, the data detailing at least one of a goal, a risk, a technology, and an expert associated with that document.

3. The method of claim 1, wherein the generating of the corpus graph from the plurality of inputs includes at least one of:
extracting corpus-wide risk concepts from the data;
identifying textual risk segments from the data; and
performing recognition operations on the data to produce recognized technology, expert, and client data.

4. The method of claim 3, further comprising:
utilizing at least one of the corpus-wide risk concepts, the textual risk segments, and the recognized data to build the statistical relational network.

5. The method of claim 4, wherein the links of the statistical relational network are associated with weights representing a probability that a connection has been correctly inferred.

6. The method of claim 1, wherein the inferring of the plurality of new relations between the informational elements of the statistical relational network associates unconnected informational elements.

7. The method of claim 6, wherein the plurality of new relations include a relation between at least one of a pair of project-project, project-expert, and project-risk informational elements.

8. The method of claim 6, wherein the inferring of the plurality of new relations includes inferring a new relation between an element of a first type and all elements of a second type includes:
computing a relatedness score between the element of the first type and each of the elements of the second type;
ranking the elements of the second type in descending order by the relatedness score;
selecting one or more of the elements of the second type with the highest scores.

9. The method of claim 8, wherein the first and second types are the same.

10. The method of claim 8, wherein the computing of the relatedness score is responsive to computing a stationary probability distribution of a random walk originating at the a of the first type.

11. The method of claim 1, wherein the plurality of summaries includes a summary for an informational element computed by selecting textual segments from unstructured textual data describing the informational element.

12. The method of claim 11 wherein the selecting of the textual segments is responsive to an occurrence of mentions of other informational elements in the unstructured data.

13. A computer program product, the computer program product comprising a computer readable storage medium having program instructions embodied therewith, the program instructions executable by a processor to cause:
receiving, by the processor, a plurality of inputs including data a plurality of multiple business repositories;
generating, by the processor, from the plurality of inputs a corpus graph as a statistical relational network;
inferring, by the processor, a plurality of new relations between informational elements of the statistical relational network; and
generating, by the processor, a plurality of summaries of the plurality of new relations, each summary describing the informational elements of the statistical relational network associated with that corresponding risk-relation.

14. The computer program product of claim 13, wherein the a plurality of inputs includes risk or project management documents, each document including at least one of structured, semi-structured, and unstructured data, the data detailing at least one of a goal, a risk, a technology, and an expert associated with that document.

15. The computer program product of claim 13, wherein the generating of the corpus graph from the plurality of inputs includes at least one of:
extracting corpus-wide risk concepts from the data;
identifying textual risk segments from the data; and
performing recognition operations on the data to produce recognized technology, expert, and client data.

16. The computer program product of claim 15, wherein the program instructions are further executable by the processor to cause:
utilizing at least one of the corpus-wide risk concepts, the textual risk segments, and the recognized data to build the statistical relational network.

17. A system, comprising a processor and a memory, the system configured to:
receive a plurality of inputs that include data a plurality of multiple business repositories;
generate from the plurality of inputs a corpus graph as a statistical relational network;
infer a plurality of new relations between informational elements of the statistical relational network; and
generate a plurality of summaries of the plurality of new relations, where each summary describes the informational elements of the statistical relational network associated with that corresponding risk-relation.

18. The system of claim 17, wherein the a plurality of inputs includes risk or project management documents,
wherein each document includes at least one of structured, semi-structured, and unstructured data, the data details at least one of a goal, a risk, a technology, and an expert associated with that document.

19. The system of claim 17, wherein the generation of the corpus graph from the plurality of inputs includes at least one of:
an extraction corpus-wide risk concepts from the data;
identification textual risk segments from the data; and
performance recognition operations on the data to produce recognized technology, expert, and client data.

20. The system of claim 19, wherein the system is further configured to:
utilize at least one of the corpus-wide risk concepts, the textual risk segments, and the recognized data to build the statistical relational network.
